(19) United States
(12) Patent Application Publication
(10) Pub. No.: US 2008/0309172 A1
(43) Pub. Date: Dec. 18, 2008

(54) Module electric tool

(76) Inventor: Yi-Chun Tseng, Taichung (TW)

Correspondence Address: PRO-TECHTOR INTERNATIONAL SERVICES, 20775 NORADA CT., SARATOGA, CA, 95070, US

(21) Appl. No.: 11/818,381

(22) Filed: Jun. 14, 2007

(51) Int. Cl. H02K 7/14

(52) U.S. Cl. 310/50; 310/71; 439/481

(57) ABSTRACT

A module electric tool comprises a lower cover including receiving compartments and a receiving cavity formed therein, an upper cover engaged with the lower cover, an gear box module received in the receiving compartment and including a rotary stem disposed at the front end thereof and an input sleeve mounted at the rear end thereof; an motor module received in the receiving compartment and including a driving shaft affixed at the front end thereof and electrical contacts formed on the rear end surface thereof, an electrical switch module received in the receiving compartment and including electrical contacts fixed at the front and rear ends thereof, respectively, and a press button attached at the peripheral side thereof, a battery module fitted in the receiving cavity and including electrical contacts provided at the front end thereof for couplingly contacting with the electrical contacts of the electrical switch module, thus obtaining an assembled convenience and lowering the production cost.

### BACKGROUND OF THE INVENTION

1. Field of the Invention

The present invention relates to an electric tool, and more particularly to a module electric tool that may obtain an assembled convenience and lower the production cost.

2. Description of the Prior Arts

Referring to FIG. 1, a prior art electric tool comprises a lower cover 10 of a grip including an assembled motor 11 and an assembled gear box 12 both received therein, wherein the gear box 12 includes a rotary stem 13 couplingly disposed at the front end thereof and having a polygonal hole 131 formed at the end portion thereof for fitting a bit 14. A lower cover 10 is provided with a switch assembly 15, a circuit board 151 of which is electrically connected to the assembled motor 11 by wires 152, and at the bottom end of the lower cover 10 is received a battery assembly 16. To electrically couple the battery assembly 16 to the switch assembly 15, a conductive piece 161 is electrically joined to the circuit board 151 for the electric transmition, and then by way of an upper cover 17 and a lower cover 10, the respective components of the prior art electric tool may be fixedly assembled together. However, after the assembly, the motor 11, the battery assembly 16 and the switch assembly 15 are electrically connected together by using wires 152 and 162, thus complicating the assembly.

The present invention has arisen to mitigate and/or obviate the afore-described disadvantages.

### SUMMARY OF THE INVENTION

The primary object of the present invention is to provide a module electric tool that the connection of the power and electricity may be achieved without any detailed assemblies, thus obtaining an assembled convenience and lowering the production cost.

Another object of the present invention is to provide a module electric tool that if desiring to replace a same-size gear box module yet with a different speed reducing ratio or with a larger output torsion, a straight replacement is obtained, and then after the replacement, a gear box module may have a power transmition with a motor module with which an electrical switch module may be electrically contacted as well, thus allowing a quick replacement.

In accordance with one aspect of the present invention, there is provided a module electric tool comprising a lower cover including first, second and third receiving compartments formed therein and including a receiving cavity provided therein as well. The first receiving compartment includes an assembled gear box module received therein and having a rotary stem disposed at the front end thereof. The rotary stem may be in the shape of a polygonal rod for fitting a socket tool therein or may be a hollowly polygonal tube for fitting a bit therein. The gear box module also includes an input sleeve mounted at the rear end thereof. The second receiving compartment includes an assembled motor module received therein and having a driving shaft affixed at the front end thereof and fitted into the input sleeve for transmitting the power of the motor module to the gear box module, the motor module further includes two electrical contacts both formed on the rear end surface thereof, the electrical contact is located at the center of the rear end surface of the motor module and may be a resilient ring, yet the electrical contact is located on the outer peripheral surface of the motor module and may be in the shape of a plane. The third receiving compartment involves an electrical switch module received therein and having a circuit board therein for controlling the circuit, and having two electrical contacts fixed at the front end thereof for couplingly contacting with the electrical contacts, and also having two electrical contacts defined at the rear end thereof and a press button attached at the peripheral side thereof. An upper cover for corresponding to the first, second and third receiving compartments and the receiving cavity is engaged with the lower cover so as to define the gear box module, the motor module and the electrical switch module in the receiving compartments. The receiving cavity contains a battery module for receiving a plurality of batteries fitted at the rear end thereof and having two electrical contacts provided at the front end thereof for couplingly contacting with the electrical contacts, and the electrical contact is located at the center of the rear end surface of the battery module and may resiliently expand and retract, while the electrical contact is located on the outer peripheral portion of the front end surface of the battery module and in the shape of a plane. The battery module includes a rotatable lid disposed at the rear end thereof for the rotatable engagement with the upper and lower covers, and during the rotatable engagement, the electrical contact may urge the electrical switch module for the sure electrical contact between the battery module, the electrical switch module and the motor module.

The present invention will become more obvious from the following description when taken in connection with the accompanying drawings, which show, for purpose of illustrations only, the preferred embodiment in accordance with the present invention.

### BRIEF DESCRIPTION OF THE DRAWINGS

FIG. 1 is a perspective diagram illustrating the exploded components of a prior art electric tool;

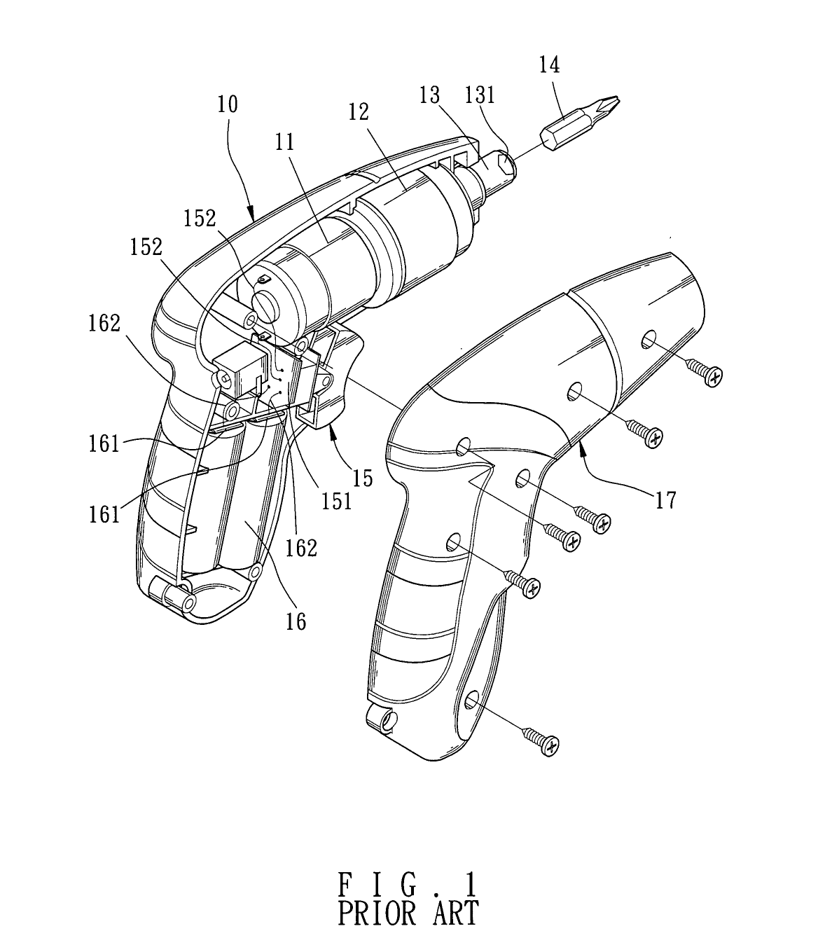

FIG. 2 is a perspective diagram illustrating the exploded components of a module electric tool according to the present invention;

FIG. 3 is a perspective diagram illustrating the assembly of the module electric tool according to the present invention;

FIG. 4 is an assembly cross-sectional diagram of the module electric tool according to the present invention;

FIG. 5 is a perspective diagram illustrating the replacement of the related components of the module electric tool according to the present invention;

FIG. 6 is perspective diagram illustrating the operational status of the module electric tool according to the present invention;

FIG. 7 is a perspective diagram illustrating the exploded components of a module electric tool according to another embodiment of the present invention;

FIG. 8 is a perspective diagram illustrating the assembly of the module electric tool according to another embodiment of the present invention;

FIG. 9 is an assembly cross-sectional diagram of the module electric tool according to another embodiment of the present invention;

FIG. 10 is perspective diagram illustrating the operational status of the module electric tool according to another embodiment of the present invention.

### DETAILED DESCRIPTION OF THE PREFERRED EMBODIMENT

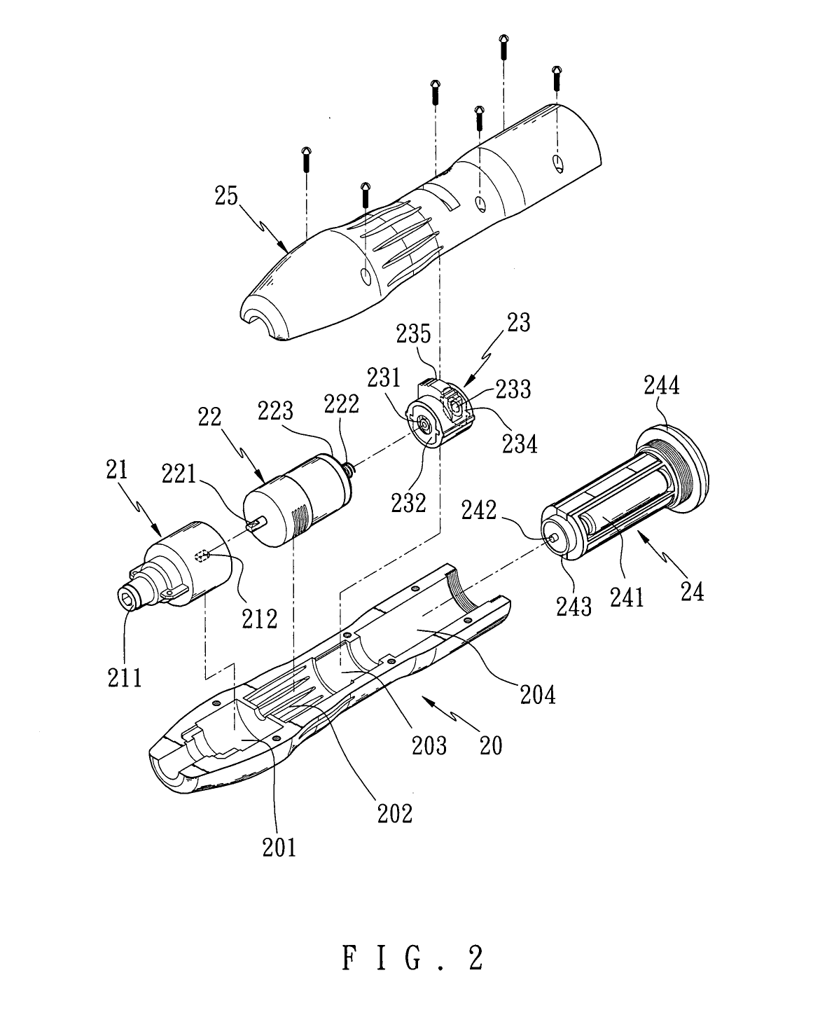

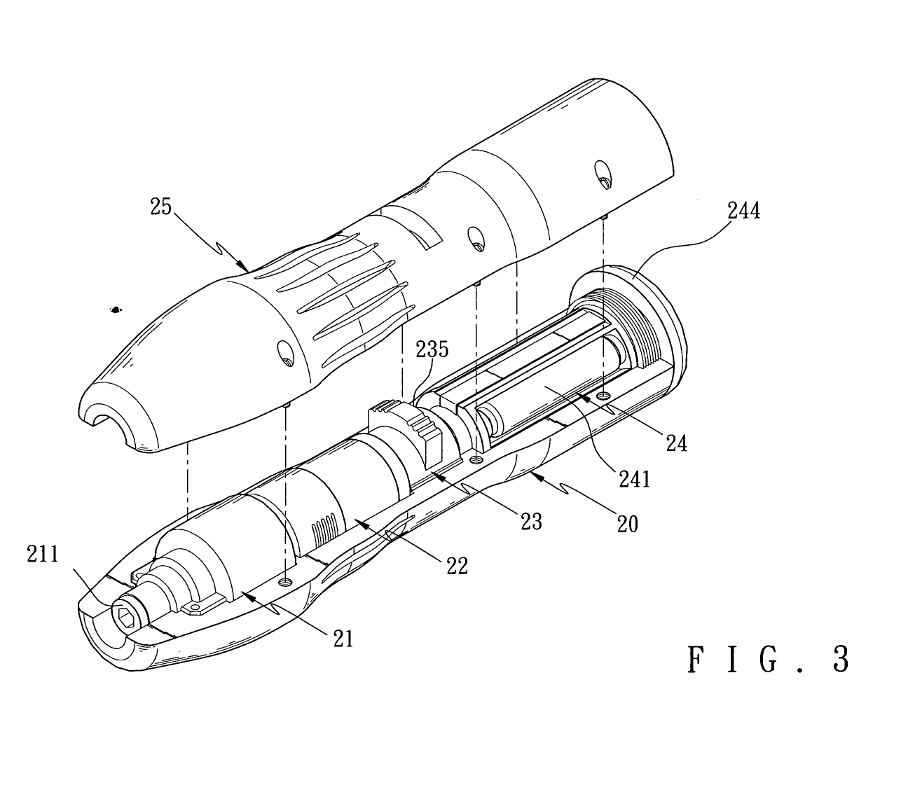

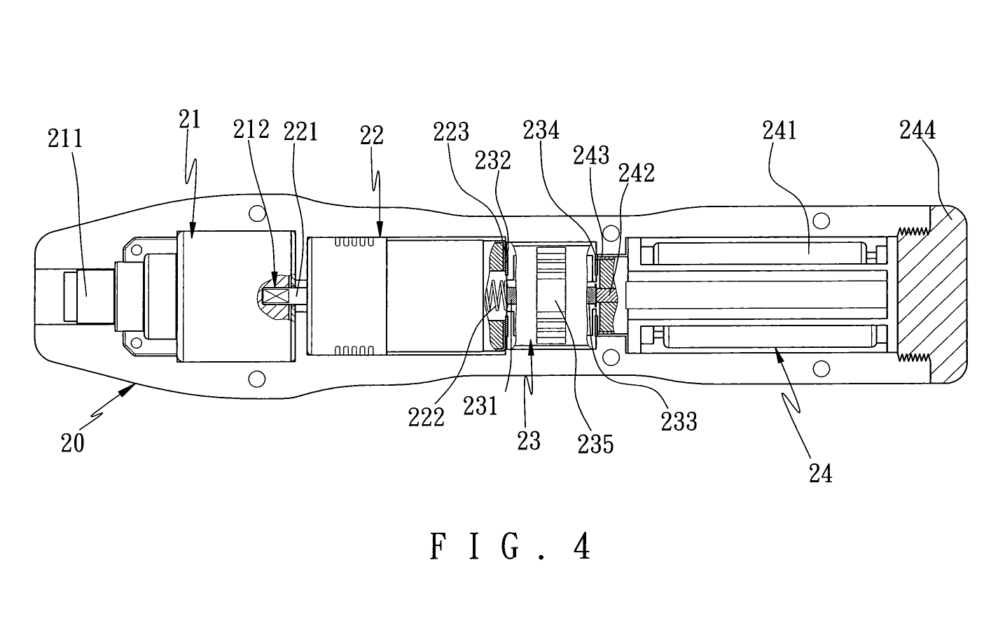

Referring to FIGS. 2-4, a module electric tool in accordance with the present invention comprises a lower cover 20 including first, second and third receiving compartments 201, 202 and 203 formed therein and including a receiving cavity 204 provided therein as well. The first receiving compartment 201 includes an assembled gear box module 21 received therein and having a rotary stem 211 disposed at the front end thereof. The rotary stem 211 may be in the shape of a polygonal rod for fitting a socket tool therein or may be a hollowly polygonal tube for fitting a bit therein. The gear box module 21 also includes an input sleeve 212 mounted at the rear end thereof. The second receiving compartment 202 includes an assembled motor module 22 received therein and having a driving shaft 221 affixed at the front end thereof and fitted into the input sleeve 212 for transmitting the power of the motor module 22 to the gear box module 21, the motor module 22 further includes two electrical contacts 222 and 223 both formed on the rear end surface thereof, the electrical contact 222 is located at the center of the rear end surface of the motor module 22 and may be a resilient ring, yet the electrical contact 223 is located on the outer peripheral surface of the motor module 22 and may be in the shape of a plane. The third receiving compartment 203 involves an electrical switch module 23 received therein and having a circuit board therein for controlling the circuit, and having two electrical contacts 231 and 232 fixed at the front end thereof for couplingly contacting with the electrical contacts 222 and 223, and also having two electrical contacts 233 and 234 defined at the rear end thereof and a press button 235 attached at the peripheral side thereof. An upper cover 25 for corresponding to the first, second and third receiving compartments 201, 202, and 203 and the receiving cavity 204 is engaged with the lower cover 20 so as to define the gear box module 21, the motor module 22 and the electrical switch module 23 in the receiving compartments 201, 202 and 203. The receiving cavity 204 contains a battery module 24 for receiving a plurality of batteries 241 fitted at the rear end thereof and having two electrical contacts 242 and 243 provided at the front end thereof for couplingly contacting with the electrical contacts 233 and 234, and the electrical contact 242 is located at the center of the rear end surface of the battery module 24 and may resiliently expand and retract, while the electrical contact 243 is located on the outer peripheral portion of the front end surface of the battery module 24 and in the shape of a plane. The battery module 24 includes a rotatable lid 244 disposed at the rear end thereof for the rotatable engagement with the upper and lower covers 25 and 20, and during the rotatable engagement, the electrical contact 242 may urge the electrical switch module 23 for the sure electrical contact between the battery module 24, the electrical switch module 23 and the motor module 22. Since the gear box module 21, the motor module 22, the electrical switch module 23 and the battery module 24 are all assembled together in a module manner, after the engagement of the upper and lower covers 25 and 20, the connection of the power and electricity may be achieved without any detailed assemblies, thus obtaining an assembled convenience. Furthermore, as far as the manufacturing and assembly are concerned, the gear box module 21, the motor module 22, the electrical switch module 23 and the battery module 24 are all made by the individual professional manufacturers and assembled together on the assembly line in a beltline manner, thereby greatly lowering the production cost.

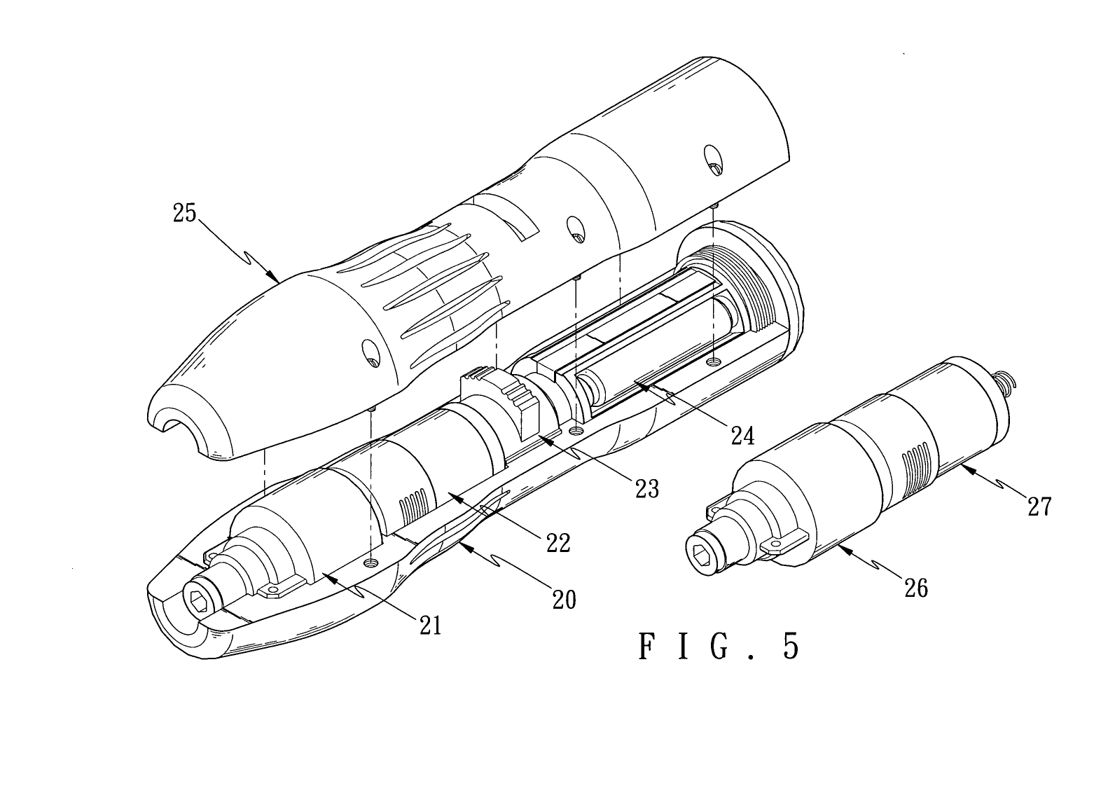

With reference to the FIG. 5, if desiring to replace the same-size gear box module 26 yet with a different speed reducing ratio or with a larger output torsion, a straight replacement is obtained, and then after the replacement, the gear box module 26 may have a power transmition with the motor module 27 with which the electrical switch module 23 may be electrically contacted as well, thus allowing a quick replacement.

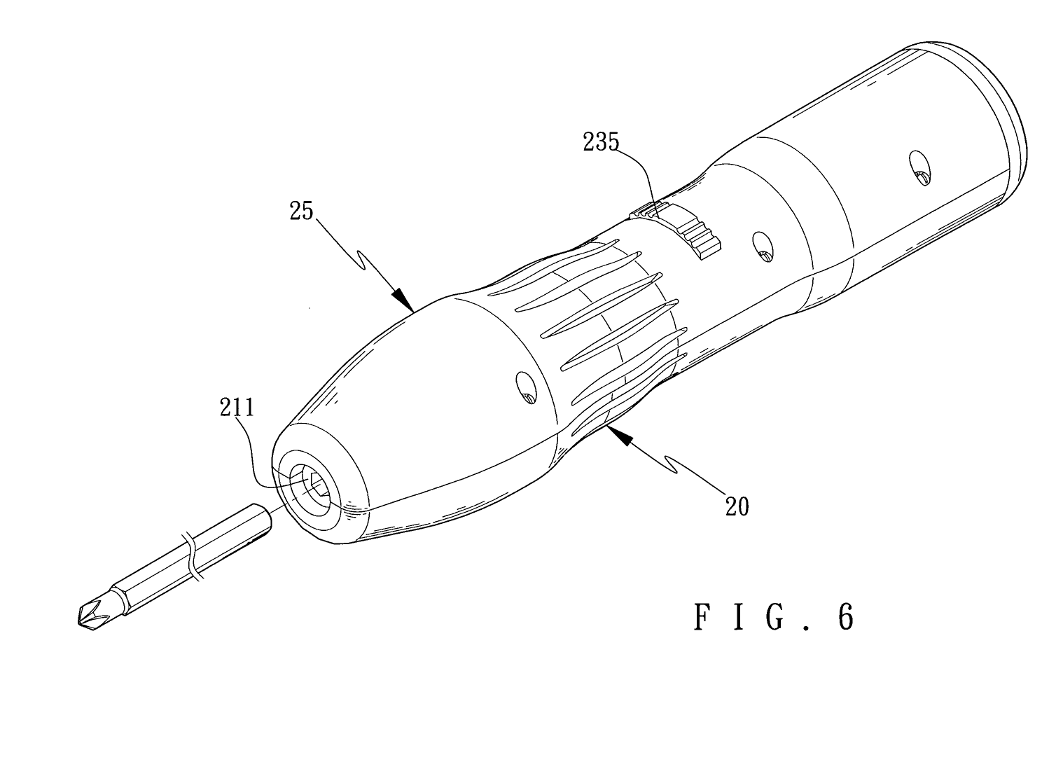

As shown in FIG. 6, behind the assembly, the rotary stem 211 of the gear box module 26 may fit a socket tool or bit therein, and through the press button 235 of the electrical switch module 23, the rotating direction of the motor may be controlled so as to have various kinds of fastening or unfastening operations.

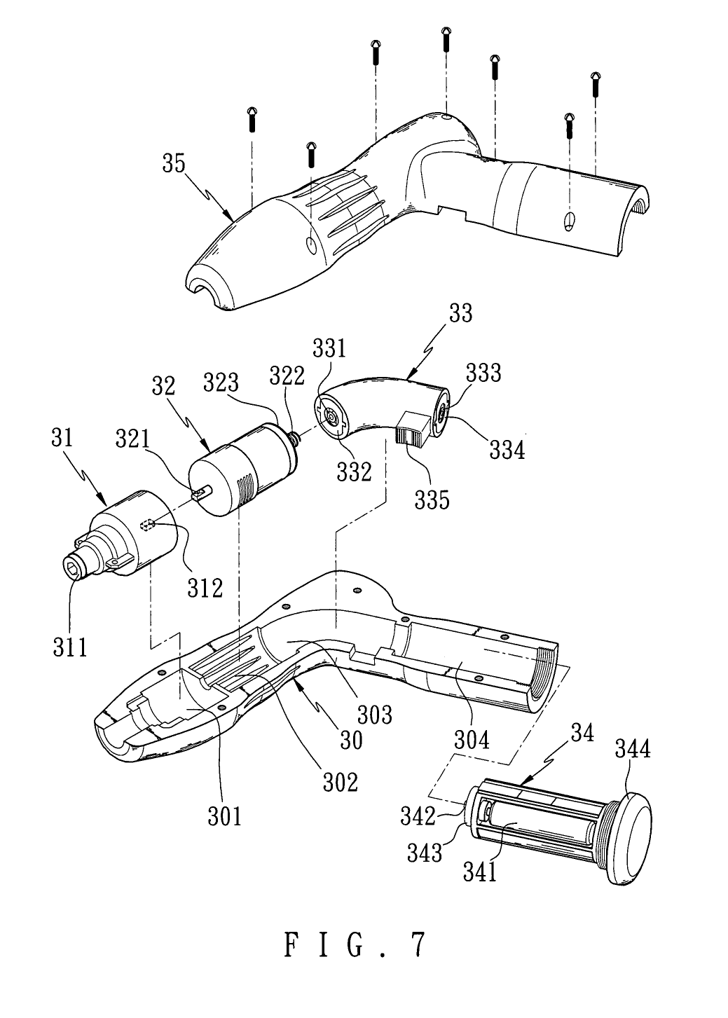

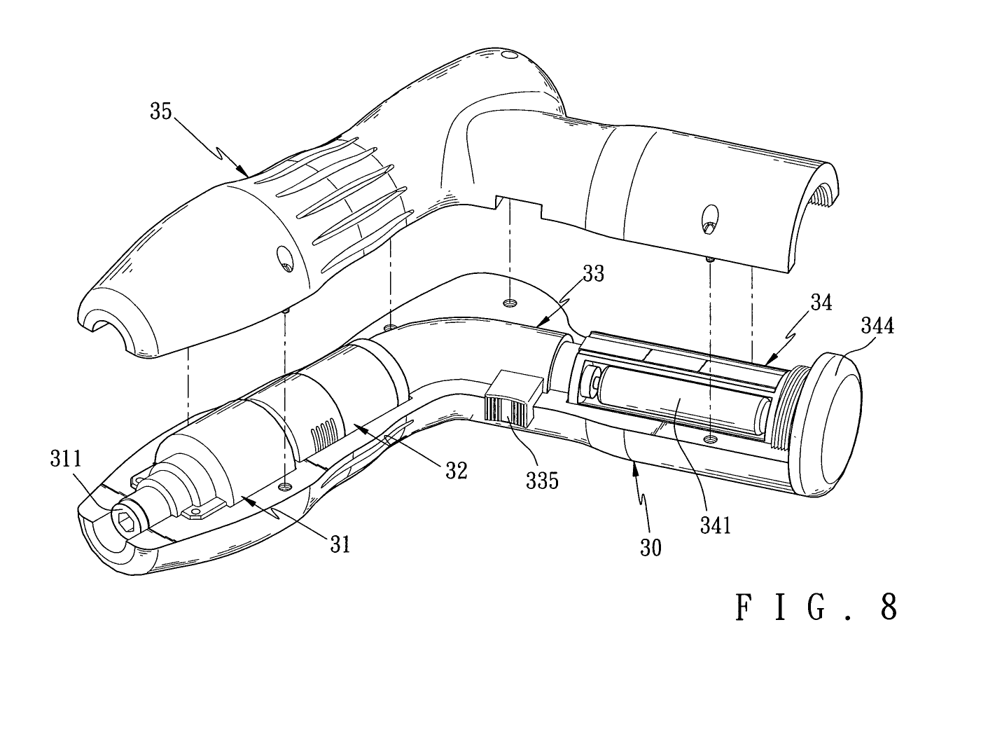

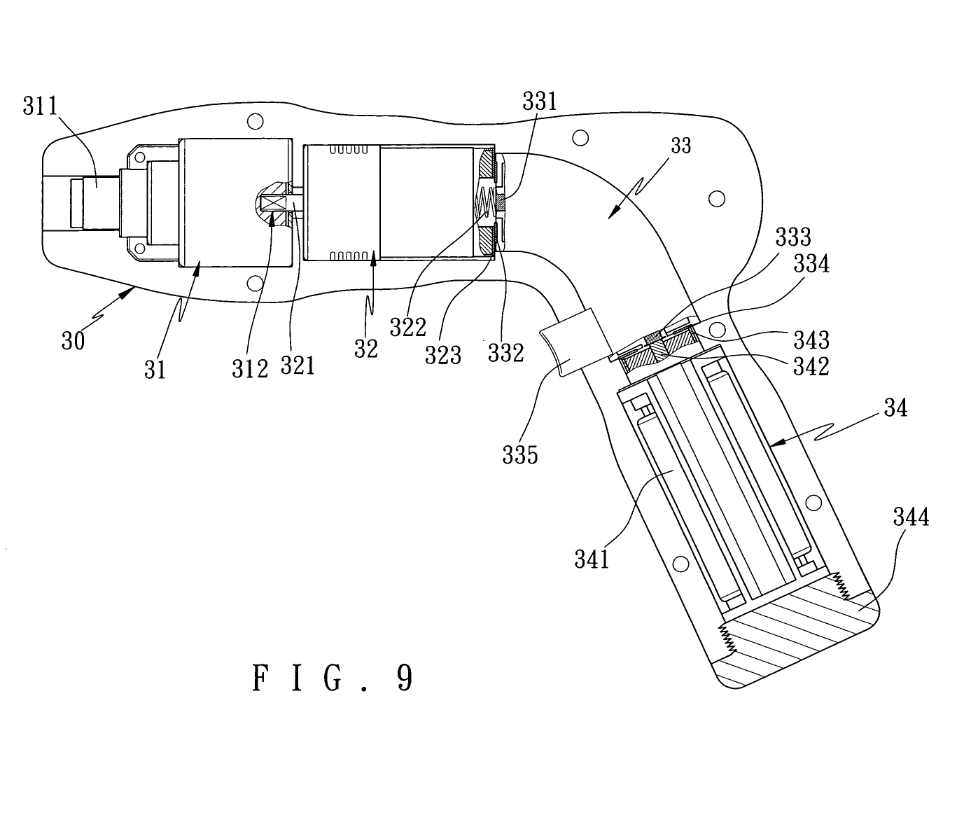

Referring to FIGS. 7-9, a gun-type of module electric tool according to another embodiment of the present invention comprises a lower cover 30 including first, second and third receiving compartments 301, 302 and 303 formed therein and including a receiving cavity 304 provided therein as well. The first receiving compartment 301 includes an assembled gear box module 31 received therein and having a rotary stem 311 disposed at the front end thereof. The rotary stem 311 may be in the shape of a polygonal rod for fitting a socket tool therein or may be a hollowly polygonal tube for fitting a bit therein. The gear box module 31 also includes an input sleeve 312 mounted at the rear end thereof. The second receiving compartment 302 includes an assembled motor module 32 received therein and having a driving shaft 321 affixed at the front end thereof and fitted into the input sleeve 312 for transmitting the power of the motor module 32 to the gear box module 31, the motor module 32 further includes two electrical contacts 322 and 323 both formed on the rear end surface thereof, the electrical contact 322 is located at the center of the rear end surface of the motor module 32 and may be a resilient ring, yet the electrical contact 323 is located on the outer peripheral surface of the motor module 32 and may be in the shape of a plane. The third receiving compartment 303 involves an electrical switch module 33 received therein and having a circuit board therein for controlling the circuit, and having two electrical contacts 331 and 332 fixed at the front end thereof for couplingly contacting with the electrical contacts 322 and 323, and also having two electrical contacts 333 and 334 defined at the rear end thereof and a press button 335 attached at the peripheral side thereof. An upper cover 35 is engaged with the lower cover 30 so as to define the gear box module 31, the motor module 32 and the electrical switch module 33 in the receiving compartments 301, 302 and 303. The receiving cavity 304 contains a battery module 34 for receiving a plurality of batteries 341 fitted at the rear end thereof and having two electrical contacts 342 and 343 provided at the front end thereof for couplingly contacting with the electrical contacts 333 and 334, and the electrical contact 342 is located at the center of the rear end surface of the battery module 34 and may resiliently expand and retract, while the electrical contact 343 is located on the outer peripheral portion of the front end surface of the battery module 34 and in the shape of a plane. The battery module 34 includes a rotatable lid 344 disposed at the rear end thereof for the rotatable engagement with the upper and lower covers 35 and 30, and during the rotatable engagement, the electrical contact 342 may urge the electrical switch module 33 for the sure electrical contact between the battery module 34 and the electrical switch module 33. Since the gear box module 31, the motor module 32, the electrical switch module 33 and the battery module 34 are all assembled together in a module manner, after the engagement of the upper and lower covers 35 and 30, the connection of the power and electricity may be achieved without any detailed assemblies, thus obtaining an assembled convenience.

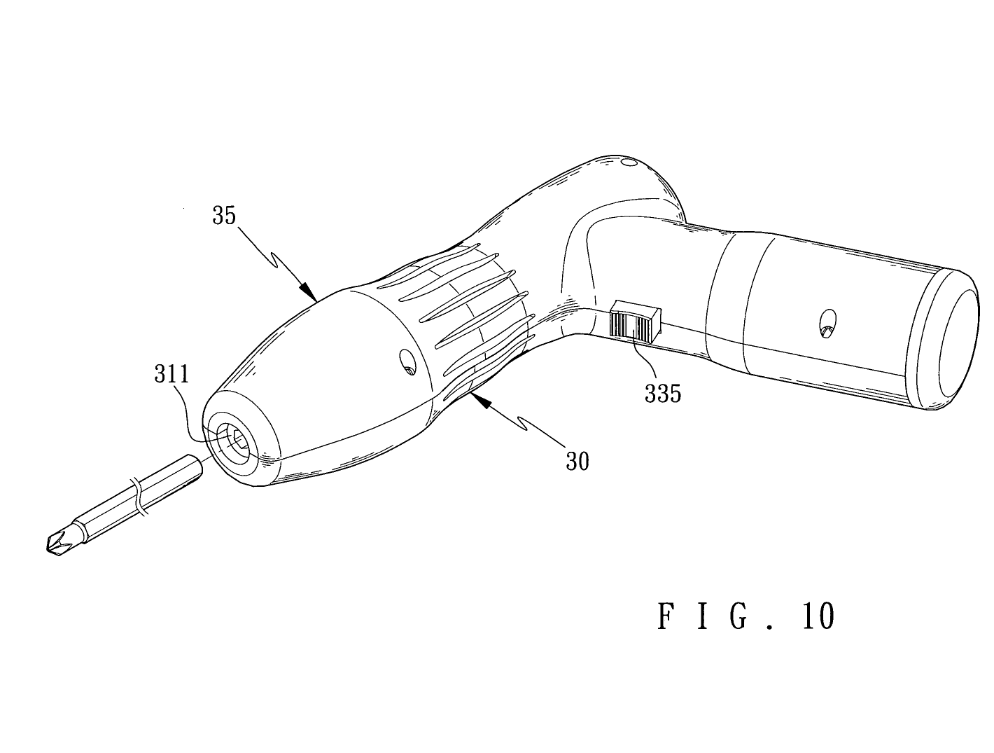

As shown in FIG. 10, behind the assembly, the rotary stem 311 of the gear box module 36 may fit a socket tool or bit therein, and through the press button 335 of the electrical switch module 33, the rotating direction of the motor may be controlled so as to have various kinds of fastening or unfastening operations.

The invention is not limited to the above embodiment but various modifications thereof may be made. It will be understood by those skilled in the art that various changes in form and detail may made without departing from the scope and spirit of the present invention.

What is claimed is:

1. A module electric tool comprising:
a lower cover including first, second and third receiving compartments and a receiving cavity formed therein;
an upper cover for corresponding to said first, second and third receiving compartments engaged with said lower cover;
an assembled gear box module received in said first receiving compartment and including a rotary stem disposed at the front end thereof, and including an input sleeve mounted at the rear end thereof;
an assembled motor module received in said second receiving compartment and including a driving shaft affixed at the front end thereof and including electrical contacts formed on the rear end surface thereof;
an electrical switch module received in said third receiving compartment and including electrical contacts fixed at the front end thereof for couplingly contacting with said electrical contacts of said motor module, and also including electrical contacts defined at the rear end thereof and a press button attached at the peripheral side thereof;
a battery module for receiving a plurality of batteries fitted in said receiving cavity and including electrical contacts provided at the front end thereof for couplingly contacting with said electrical contacts of said electrical switch module.

2. The module electric tool as claimed in claim 1, wherein said rotary stem may be in the shape of a polygonal rod for fitting a socket tool.

3. The module electric tool as claimed in claim 1, wherein said rotary stem may be a hollowly polygonal tube for fitting a bit therein.

4. The module electric tool as claimed in claim 1, wherein one electrical contact of said motor module is located at the center of the rear end surface of said motor module and may be a resilient ring, yet another electrical contact thereof is located on the outer peripheral surface of said motor module and may be in the shape of a plane.

5. The module electric tool as claimed in claim 1, wherein said electrical switch module includes a circuit board disposed therein for controlling the circuit.

6. The module electric tool as claimed in claim 1, wherein one electrical contact of said battery module is located at the center of the rear end surface of said battery module and may resiliently expand and retract, while another electrical contact thereof is located on the outer peripheral portion of the front end surface of said battery module and in the shape of a plane.
